(19) United States
(12) Patent Application Publication
(10) Pub. No.: US 2026/0303476 A1
(43) Pub. Date: Oct. 1, 2026

(54) ENHANCEMENT ON NETWORK (NW)-SIDE AI/ML DATA MANAGEMENT

(71) Applicant: Rakuten Mobile, Inc., Tokyo (JP)

(72) Inventor: Awn MUHAMMAD, Tokyo (JP)

(73) Assignee: Rakuten Mobile, Inc., Tokyo (JP)

(21) Appl. No.: 19/574,548

(22) Filed: Mar. 23, 2026

Related U.S. Application Data
(60) Provisional application No. 63/779,053, filed on Mar. 27, 2025.

(51) Int. Cl. H04L 41/16; H04W 24/08; H04W 24/10

(52) U.S. Cl. CPC H04L 41/16; H04W 24/08; H04W 24/10

(57) ABSTRACT

Example embodiments of this disclosure relate to enhancement on network-side (NW-side) Artificial Intelligence and/or Machine Learning (AI/ML) data management. According to example embodiments, a system may include a network entity that may be configured to transmit, to a user equipment (UE), a message including a configuration associated with a data logging session for collecting data associated with an AI/ML model. The configuration may be associated with at least one of: a logging entry structure that indicates a content of data to be logged by the UE, or a logging sampling interval for logging the data. The network entity may be configured to receive, from the UE, a measurement report associated with the data logging session. The measurement report may include at least one of: a log entry produced by the UE according to the logging entry structure, or data sampled by the UE according to the logging sampling interval.

### CROSS REFERENCE TO RELATED APPLICATION

This application claims priority to U.S. Provisional Patent Application No. 63/779,053, filed with the U.S. Patent and Trademark Office on Mar. 27, 2025, the entire contents of which are incorporated herein by reference.

### TECHNICAL FIELD

The present disclosure relates to the enhancement on network-side (NW-side) Artificial Intelligence and/or Machine Learning (AI/ML) data management.

### BACKGROUND

The information disclosed in this background section is only for the enhancement of understanding of the general background of the disclosure and should not be taken as an acknowledgement or any form of suggestion that this information forms the prior art already known to a person skilled in the art.

In modern wireless communication systems or networks (e.g., 5G New Radio (NR)-based networks, Open Radio Access Network (O-RAN)-based networks, etc.), Artificial Intelligence (AI) and/or Machine Learning (ML) are increasingly utilized to optimize network performance and operations. A specific configuration may involve the deployment (e.g., training, updating, executing, etc.) of AI/ML models for optimizing network operations. For instance, the AI/ML models may be deployed within one or more network components, such as a base station (e.g., 5G gNodeB, etc.), a radio access network (RAN) node, a core network entity, or the like, to provide network-related operations or services (e.g., network optimization, network operation automation, etc.). For descriptive purposes, such a configuration may be referred to as the “NW-side AI/ML” herein.

The deployment and continuous operation of the NW-side AI/ML may involve the collection and processing of massive amounts of data characterized by a wide range of varieties and temporal dynamics. Effective and efficient management of this high-volume, heterogeneous data (“AI/ML data” herein) is critical to enable accurate and reliable AI/ML-driven operations, as the performance of the AI/ML models relies on the comprehensiveness, completeness, and timeliness of the AI/ML data utilized for training and inference.

### SUMMARY

Example embodiments of the present disclosure provide systems, methods, and the like, that effectively and efficiently enhance NW-side AI/ML data management.

According to example embodiments, a system may include a network entity that may be configured to transmit, to a user equipment (UE), a message comprising a configuration associated with a data logging session for collecting data associated with an AI/ML model. The configuration may be associated with at least one of: a logging entry structure that indicates a content of data to be logged by the UE, or a logging sampling interval for logging the data. Further, the network entity may be configured to receive, from the UE, a measurement report associated with the data logging session. The measurement report may include at least one of: a log entry produced by the UE according to the logging entry structure, or data sampled by the UE according to the logging sampling interval.

According to example embodiments, a method may include transmitting, by a network entity and to a UE, a message comprising a configuration associated with a data logging session for collecting data associated with an AI/ML model. The configuration may be associated with at least one of: a logging entry structure that indicates a content of data to be logged by the UE, or a logging sampling interval for logging the data. Further, the method may include receiving, by the network entity and from the UE, a measurement report associated with the data logging session. The measurement report may include at least one of: a log entry produced by the UE according to the logging entry structure, or data sampled by the UE according to the logging sampling interval.

According to example embodiments, a non-transitory computer-readable recording medium having recorded thereon instructions executable by a network entity to cause the network entity to perform a method. The method may include transmitting, to a UE, a message comprising a configuration associated with a data logging session for collecting data associated with an AI/ML model. The configuration may be associated with at least one of: a logging entry structure that indicates a content of data to be logged by the UE, or a logging sampling interval for logging the data. Further, the method may include receiving, by from the UE, a measurement report associated with the data logging session. The measurement report may include at least one of: a log entry produced by the UE according to the logging entry structure, or data sampled by the UE according to the logging sampling interval.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example system configuration, according to one or more example embodiments;

FIG. 2 to FIG. 6 each illustrates an example method, according to one or more example embodiments;

FIG. 7 illustrates an example device/apparatus that may implement one or more example embodiments; and

FIG. 8 illustrates an example environment in which systems, devices, and/or methods, according to one or more example embodiments, may be implemented.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

It shall be noted that, descriptions of example embodiments of the present disclosure may include terms and names defined in one or more standard organizations, such as the Open Radio Access Network (O-RAN) Alliance, the 3rd Generation Partnership Project (3GPP) standard organization, the European Telecommunications Standards Institute (ETSI) standard organization, and the like. For instance, the terms “RRC message,” “MAC CE,” “IE,” “L3,” “L1,” “MDT,” “CSI,” “CSI-RS,” “ ” SSB, “SINR,” “RSRP,” “TRP,” “RSTD,” “PCI,” “SFN,” “PRS,” “RLF,” and the like, as well as the associated features, operations, interfaces, and messages involved therein, are to be interpreted as consistent with those specified in one or more technical specifications, unless being described otherwise.

In the present disclosure, specific tasks may be performed using Artificial Intelligence and/or Machine Leaning (AI/ML) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc. In the following, terms like “the AI model” may refer to “one or more AI models,” “one or more ML models,” “one or more AI models and ML models,” and the like.

Although AI and ML may be explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

In addition, reference throughout the specification to “data collection,” “logging,” or similar terminology may refer to the process that involves one or more operations such as: monitoring, measuring, obtaining, sampling, buffering, or recording data associated with one or more AI/ML operations. Said terminologies may be used interchangeably herein, without departing from the scope of the present disclosure.

As described above, in a network-side (NW-side) configuration, one or more AI/ML models may be deployed (e.g., deployed by one or more network entities such as a base station, a radio access network (RAN), core network, etc.) to provision network-related operations or services (e.g., network resource optimization, network automation, etc.). In this regard, the efficacy and accuracy of these AI/ML models may rely on the quality, timeliness, and completeness of the data utilized for implementing the AI/ML models. For example, when training an AI/ML model designed to optimize beam management, if the collected training data fails to capture critical or timely radio conditions (e.g., due to insufficient logging durations or delayed reporting, etc.), the resulting AI/ML model (trained based on the collected training data) may be unable to accurately predict dynamic channel changes, leading to suboptimal beam management when the AI/ML model is executed for beam management operations.

As also described above, the deployment and continuous operation of the NW-side AI/ML configuration may involve the collection and processing of massive amounts of data (“AI/ML data” herein). This AI/ML data may be characterized by a wide range of varieties and temporal dynamics. In this regard, a major portion of these high-volume, heterogeneous data may be collected or aggregated by one or more user equipment (UEs), such as customer devices (e.g., smartphones, tablets, wearables, etc.), specialized terminals (e.g., vehicles, industrial internet of things (IoT) sensors, etc.), and the like. Further, the AI/ML data may include, for example, radio/network-related data (e.g., Channel State Information (CSI), Signal-to-Interference-plus-Noise Ratio (SINR), beam measurements, etc.), UE-related data (e.g., power consumption, supported features, operational states, etc.), user-related data (e.g., application usage statistics, traffic demand patterns, mobility routines, etc.), and the like.

In view of the above, the communication among the network entity(s) and the UE is an important aspect in managing AI/ML data for NW-side AI/ML deployment. For instance, the signaling between the network component(s) and the UE may affect how efficiently and effectively the network entity(s) may inform the UE regarding, for example, the specific requirements for collecting AI/ML data for NW-side AI/ML deployment. Similarly, the quality of this communication may determine the ability of the UE to accurately capture and efficiently report the targeted AI/ML data to the network entity(s), ensuring that the collected datasets are sufficiently comprehensive for NW-side AI/ML deployment while minimizing the transmission of redundant information and reducing the signaling overhead on the radio interface.

Nevertheless, data management mechanisms in the related art, such as Minimization of Drive Tests (MDT) or standard periodic measurement reporting, have been used for general network optimization (e.g., coverage analysis, failure detection, etc.) and were not originally designed to meet the rigorous and dynamic requirements of AI/ML-related operations, such as AI/ML model training, AI/ML model inference, and the like. Rather, there are no standardized or specified mechanisms available in the related art that enable efficient and effective NW-side AI/ML data management. In the following, the shortcomings of the related art are described for the following four aspects:
(1) Logging Content and Sampling Behavior;
(2) Beam Filtering and Granularity Control;
(3) Dataset Purpose and Multi-Use Case Labeling; and
(4) Session Management and Interruption Recovery.

Regarding aspect (1), while the triggering mechanism for data collection/logging has been introduced in the related art (e.g., triggering based on Layer 3 (L3) events such as serving cell reference signal received power (RSRP) crossing thresholds, etc.), the logging content after the triggering of the data collection/logging remains unspecified. In this regard, the collected data (or “log”) may need to include a specific type of data (e.g., beam-specific measurements, timestamps, association with resource configuration, etc.) to ensure the collected data is valid across both model and deployment boundaries. Namely, in the related art, the logging content (e.g., per sampling interval) is not defined, resulting in ambiguity across UE implementations.

The “sampling” described herein may refer to the process of monitoring, capturing, and recording specific data, while the “sampling interval” described herein may refer to a specific time duration or an event defining how frequently the data is sampled. In this regard, in addition to the logging content per sampling interval (“sampling content” herein), the sampling interval is also not standardized and remains unspecified in the related art, leading to data (e.g., training data) inconsistency across devices and configurations.

Furthermore, while beam prediction has been introduced in the related art for driving data collection/logging, positioning models (e.g., location management function (LMF)-side models, etc.), which may be trained to estimate a device's location based on radio signal characteristics, may introduce new data requirements. For instance, unlike beam management, the performances of positioning models may depend significantly on specific information, such as precise timing offset measurements (e.g., reference signal time difference (RSTD), etc.), positioning reference signal (PRS) resource mappings, and the like, that are not captured by the mechanisms in the related art (e.g., CSI report configurations, MDT reporting mechanisms, etc.). Moreover, the nature of PRS logging in the related art is inherently tied to downlink (DL) timing behavior and may need to be adjusted (e.g., to reflect transmitter-specific metadata such as transmission reception point (TRP) identifier (ID), etc.), in order to be useful for positioning-related AI/ML operations (e.g., positioning inference, etc.). Nevertheless, such adjustments are not suggested or disclosed in the related art. Further, the log formats in the related art do not support DL-PRS measurements, limiting support for LMF-side positioning model operations (e.g., training, inference, etc.).

Furthermore, vendors may wish to log additional data (e.g., modem-specific fields, preprocessed metrics, intermediate inference results, etc.) as part of internal model training workflows. Nevertheless, there is no defined or standardized mechanisms in the related art that enable the logging structure to include information for vendor use. Notably, rigid logging formats may discourage proprietary model development and experimentation.

Regarding aspect (2), the logging of all beams per sampling intervals can overwhelm the UE buffer, reducing the efficiency or effectiveness of data collection/logging, particularly when many beams yield low-value data (e.g., those with low RSRP, low spatial diversity, etc.). In this regard, since AI/ML-related operations (e.g., model training, etc.) are more efficient when the collected data/logs focus on dominant beams or those within a meaningful delta (e.g., within a threshold such as 3 dB of the top beam, etc.), there is a need to perform beam filtering in order to reduce the amount of less-meaningful data. Theoretically, performing the beam filtering at the point of capture (e.g., UE), is more feasible and efficient, since offloading the beam filtering to post-processing is inefficient. Nevertheless, there is no specified or standardized beam filtering mechanism in the related art for NW-side AI/ML purposes. Without beam filtering, the volume of the logged data may be unbounded and model utility may degrade.

Regarding aspect (3), in the scenarios where a UE is simultaneously logging data for multiple AI/ML use cases (e.g., DL beam management, positioning via PRS, CSI reconstruction, etc.), the use cases may differ in how logs are post-processed, labeled, and fed into model pipelines. Nevertheless, the data logging mechanisms in the related art (e.g., MDT, etc.) implicitly assume that the logged data is for a single Operations, Administration and Maintenance (OAM)-related purpose, and thus, do not include specific labelling or categorization in the context of the logged data. Without tagging of the dataset purposes or labeling of the associated use case(s), the same log data could be misrouted to incorrect model pipelines (e.g., incompatible models, etc.), leading to poor accuracy or training failure.

Regarding aspect (4), in the scenarios of mobility events (e.g., handover, etc.), although the UE may retain logs or collected data after the mobility events (e.g., post-handover) and report availability thereof, there are no standardized or specified mechanisms in the related art for tracking data logging session continuity or seamlessly resuming the data logging session. As a result, the data logged or collected before and after the mobility events may be duplicated or ambiguous, particularly when the AI/ML-related operations have specific/strict dataset requirements (e.g., datasets are required to be stitched together and session-aware for time-sequence learning, etc.).

Further, unlike legacy MDT mechanisms in the related art (where the capabilities of UEs were assumed to be uniform across different UEs), AI/ML logging use cases may require a more flexible or detailed configuration approach, since some UEs may have different capabilities in performing AI/ML logging (e.g., some UEs may support multiple logging sessions while some UEs may not, some UEs can log at 20 ms intervals while other may only support 80 ms or longer, etc.). Without declaring the limitations of the UEs upfront, the network may risk configuring the data logging sessions that fail silently. Moreover, with the advancement of NW-side AI/ML, it becomes increasingly important for the network to adapt logging strategies based on UE capacities or capabilities. Nevertheless, there are no specified or standardized mechanisms in the related art to enable the network to query the UE's logging-related limitations, which may risk over-configuration and failure to capture datasets for NW-side AI/ML purposes.

Furthermore, as AI/ML use cases multiply, the likelihood that a UE being configured to log multiple datasets concurrently has increased significantly. For instance, a UE may be configured to concurrently log (a) beam power data for gNB-side model training, (b) PRS measurements for LMF-side positioning model training, and (c) CSI feature sets for future channel reconstruction models. To maintain clarity in dataset management and model separation, there is a need to provide distinct configurations per dataset purpose. Nevertheless, there are no defined or standardized mechanisms in the related art for configuring or managing multiple AI/ML logging sessions concurrently in a scoped and clear manner.

Example embodiments of the present disclosure provide systems, methods, mechanisms, and the like, that efficiently and effectively enhance the management of data associated with NW-side AI/ML, thereby addressing one or more of the problems described above with respect to aspects (1) to (4).

Specifically, with respect to aspect (1), example embodiments of the present disclosure introduce and exemplify an AI/ML data logging framework that enhances AI/ML data logging content and sampling behavior. For instance, the example embodiments define or specify a logging entry structure that contains one or more fields associated with AI/ML data (e.g., timestamps, resource identifiers, etc.) to resolve implementation ambiguity across UEs.

Further, the example embodiments introduce the inclusion of one or more parameters indicating a logging sampling interval (e.g., align with CSI-RS transmission, performing logging sampling at a fixed interval, etc.) in a message (e.g., radio resource control (RRC) message, etc.) provided by the network entity to the UE to configure or standardize the sampling intervals across devices and configurations, thereby providing a balance between data consistency and sampling interval configurability.

Furthermore, in the scenarios that involve positioning AI/ML-related operations (e.g., positioning AI/ML model training, etc.), the example embodiments define or specify a logging entry structure that contains one or more fields associated with DL-PRS (e.g., PRS resource identifier, timing offset, etc.), thereby effectively supporting LMF-side model training. The aforesaid field(s) and/or parameter(s) may be included by extending one or more containers of one or more existing reporting mechanisms (e.g., MDT measurement report, etc.), thereby ensuring that the AI/ML-relevant information or identifiers may be added while reusing the existing reporting mechanisms whenever possible.

In addition, example embodiments of the present disclosure introduce and exemplify a mechanism to enhance the extensibility of logs (or logged data). For instance, example embodiments introduce the inclusion of a parameter (e.g., field, container, etc.) within the logging entry structure that enables the addition of vendor-specific information (e.g., modem-specific parameters, intermediate inference results, etc.) into the logs (or logged data), which may be processed by recognizing entities (e.g., vendor-related entity) while being safely ignored by other network entities that do not recognize the parameter (e.g., field, container, etc.). Accordingly, example embodiments may effectively and efficiently support vendor-specific proprietary model development without compromising the network entity's interoperability.

With respect to aspect (2), example embodiments of the present disclosure introduce and exemplify a mechanism that enhances beam filtering and provides granularity control. For instance, the example embodiments introduce the inclusion of one or more parameters indicating configurations of beam filtering (e.g., filtering mode, number of beams to retain, etc.) in a message (e.g., RRC message, etc.) provided by the network entity to the UE to constrain or filter the number of beam measurements the UE retains per sample, thereby implementing the beam filtering at the UE to minimize the volume of low-value beam data and avoid model utility degradation.

With respect to aspect (3), example embodiments of the present disclosure introduce and exemplify a mechanism that enhances logging configuration to label the purpose of logged datasets according to the associated use case(s). For instance, example embodiments introduce the inclusion of one or more parameters indicating data collection purpose(s) within logging configuration and reporting messages that enable the UE to explicitly tag or indicate the intention of the collated dataset (e.g., intended training category, etc.), thereby ensuring that the collected data is correctly routed to the compatible and associated AI/ML model pipeline and preventing the ingestion of mismatched or incompatible data types.

With respect to aspect (4), example embodiments of the present disclosure introduce and exemplify a mechanism that enhances session management and interruption recovery during mobility events (e.g., handover, radio link failure, etc.). For instance, example embodiments introduce the inclusion of a logging session identifier configured per session in logs (or logged data) and reporting messages, as well as the inclusion of a log resumption marker in logs (or logged data) after the mobility events, thereby enable the tracking of session continuity and resumption of data logging session after the mobility events, effectively avoiding ambiguous or duplicated datasets.

Further, example embodiments of the present disclosure exemplify and introduce a mechanism that enhances logging capability advertisement of the UE by extending the UE capability signaling with one or more parameters or fields that indicate logging capability of the UE. Accordingly, the UE may efficiently and effectively inform the associated logging capability to the network, thereby enabling the network to adapt logging strategies based on the UE's logging capability and avoid over-configuration or failure to capture datasets.

Furthermore, example embodiments of the present disclosure exemplify and introduce a mechanism to configure or manage multiple AI/ML logging sessions concurrently in a scoped, clear way. For instance, example embodiments introduce or define a configuration structure that allows the configuration and management of multiple simultaneous logging sessions associated with different AI/ML purposes. Further, example embodiments introduce the inclusion of per-session report flags and availability indication in one or more messages provided by the UE to the network, thereby enabling the network to effectively and efficiently support distinct configurations per dataset purpose, maintaining clarity in dataset management and model separation.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture and Configurations

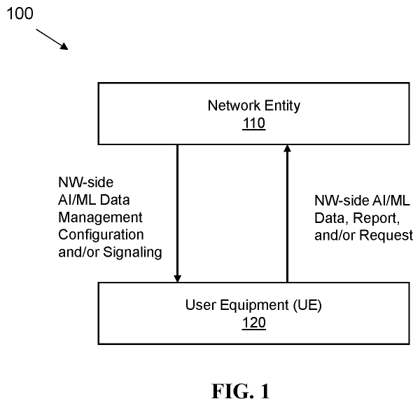

FIG. 1 illustrates a generic system configuration 100, according to one or more example embodiments. As illustrated in FIG. 1, the system configuration 100 includes a network entity 110 and a user equipment (UE) 120. The network entity 110 may be communicatively coupled to the UE 120 via one or more networks and/or interfaces, and may be configured to exchange information or messages for network-side (NW-side) AI/ML purposes.

As described above, in a network-side (NW-side) configuration, one or more network entities may implement or deploy (e.g., train, update, execute, etc.) one or more AI/ML models to provide network-related operations or services. In this regard, “NW-side AI/ML purposes,” “AI/ML-related operations,” and similar descriptions as used herein may include, but are not limited to: the training of AI/ML model(s) at one or more network entities (e.g., using aggregated or filtered data received from the UE 120, etc.), the execution or inference of AI/ML model(s) at the network entity(s) for network automations (e.g., automated fault recovery, automated load balancing, etc.) and/or network optimizations (e.g., beam management, radio resource allocation, etc.), the provisioning and management of AI/ML-driven services, the continuous lifecycle management of AI/ML model(s) (e.g., performance monitoring, model retraining/fine-tuning, model switching to adapt to dynamic radio environments, etc.), and any other suitable type of activities or utilization of AI/ML model(s) that involve the network entity(s).

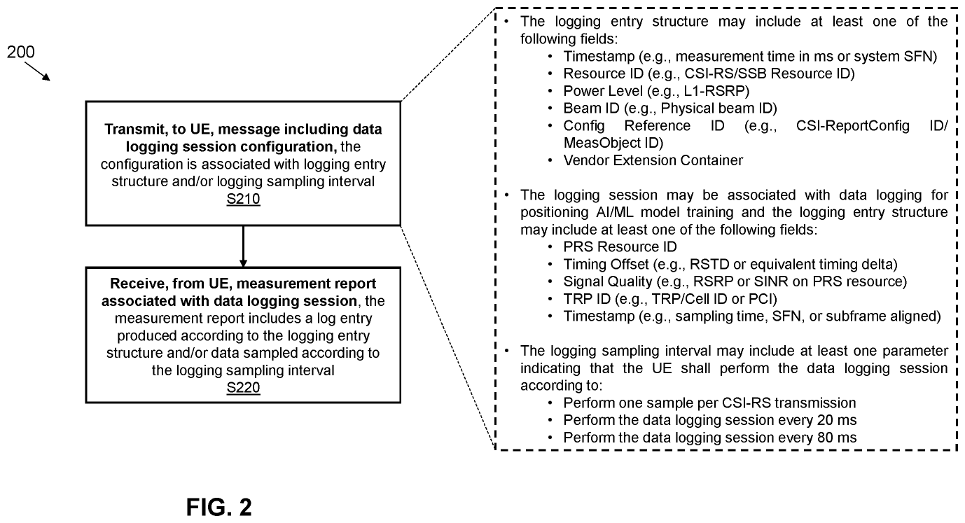

Further, the “NW-side AI/ML data” described herein may include data associated with the network, the UE, or any other suitable data, that may be utilized by the network entity 110 for NW-side AI/ML purposes. For instance, as further described below with reference to FIG. 2 to FIG. 6, the NW-side AI/ML data may include, but not limited to: radio measurement data (e.g., signal strength, interference trends, etc.), beam-related data (e.g., beam transitions, beam-level metrics, etc.), Channel State Information (CSI)-related data (e.g., CSI measurement trends, CSI feedback, etc.), mobility-related data (e.g., handover parameters, trajectory logs, mobility patterns, etc.), UE-internal status data (e.g., power consumption, storage availability, motion trajectory, beam selection metric, etc.), network-related operational data (e.g., network traffic/load, resource block utilization, etc.), AI/ML-related metadata (e.g., dataset classification/categorization information, model identifiers, performance feedback, etc.), and the like.

The network entity 110 may include one or more physical or logical network nodes within a network (e.g., 4G LTE network, 5G network, Open Radio Access Network (O-RAN)-based network, etc.) that may be configured to perform management, control, and/or processing of NW-side AI/ML data. For instance, the network entity 110 may include, but is not limited to: a base station (e.g., a 4G eNodeB, a 5G gNodeB, etc.), a RAN node (e.g., Next Generation RAN (NG-RAN), Open RAN (O-RAN), etc.) or an associated component (e.g., a Radio Intelligent Controller (RIC), a Centralized Unit (CU), etc.), a core network function or entity (e.g., an Access and Mobility Management Function (AMF), a User Plane Function (UPF), a Network Data Analytics Function (NWDAF), etc.), an AI/ML management or orchestration node, a cloud-based server, or any other suitable network node that may be configured to manage or deploy AI/ML model(s) for NW-side AI/ML purposes.

The UE 120 may include any suitable device, terminal, apparatus, or system that may communicate with the network entity 110 via a wireless connection, a wired connection, or a combination thereof. The UE 120 may also communicate with the network entity 110 via any suitable interfaces, such as those defined in one or more technical documents of one or more standard organizations (e.g., 3GPP, O-RAN Alliance, etc.). By way of example, the UE 120 may include, but is not limited to: a mobile device (e.g., a mobile phone/smartphone, a tablet, a laptop, a wearable device such as smartwatches and smartglasses, a portable hotspot, a wireless sensor, etc.), a static device (e.g., an Internet of Things (IoT) device such as sensors and smart home/office devices, an internet router, etc.), a vehicle to everything (V2X) communication terminal, a drone or unmanned aerial vehicle (UAV), or any other suitable terminal or device that may be configured to provide a request and/or report data to the network entity 110 for NW-side AI/ML purposes.

As illustrated in FIG. 1, the network entity 110 and UE 120 may communicate and interoperate with each other to facilitate the management of AI/ML data or datasets involved in or associated with NW-side AI/ML purposes. Generally, the communication between the network entity 110 and UE 120 may involve the exchange of management configuration and/or signaling in the downlink and the transmission of AI/ML data, reports, and/or requests in the uplink.

The NW-side AI/ML data management configuration and/or signaling provided by the network entity 110 to the UE 120 may include various control-plane messages and/or lower-layer signals that may include configurations or parameters that instruct or guide the UE 120 to perform one or more operations to appropriately collect and manage the AI/ML data, such as (but not limited to): data logging session configuration (e.g., configurations of logging sampling interval, logging entry structure, UE's response/reporting extension, etc.), data filtering configuration, data labeling configuration, data logging session management configuration, request for UE's logging capability, and the like. The network entity 110 may provide the NW-side AI/ML data management configuration and/or signaling to the UE 120 via various methods, such as (but not limited to): including the desired configurations or parameters into one or more Information Elements (IEs) of a Radio Resource Control (RRC) message or a Medium Access Control (MAC) Control Element (CE).

On the other hand, the NW-side AI/ML data, report, and/or request provided by the UE 120 to the network entity 110 may include the information required for the network entity 110 to deploy (e.g., train, manage, execute, etc.) one or more AI/ML models for NW-side AI/ML purposes. In addition to or in alternative to the above-mentioned NW-side AI/ML data, the UE 120 may provide a measurement report (e.g., MDT report, RRC measurement report, etc.) that contains the collected or logged NW-side AI/ML data (which may be processed according to one or more configurations defined by the network entity), a request (e.g., a request for additional data collection/logging sessions or associated resources, a request for dataset adaptation based on internal conditions of the UE, etc.), or the like.

According to example embodiments, the communication between the network entity 110 and UE 120 may involve a coordinated or hybrid interaction. Specifically, while the network entity 110 may provide the foundational configuration and oversight, the UE 120 may actively participate in the management of the NW-side AI/ML data by, for example, providing real-time (or near real-time) reports and data collection/logging triggering requests based on its localized observations of the radio environment and/or its internal operational status. Accordingly, this bidirectional information exchange may ensure that the NW-side AI/ML data is collected and managed in an efficient, responsive, and standardized manner.

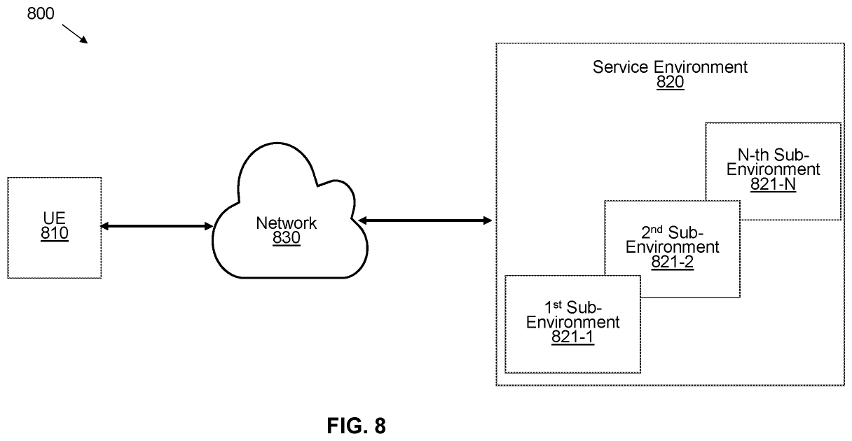

It is contemplated that the configuration in FIG. 1, as well as the described features and mechanisms, are merely examples and the scope of the present disclosure should not be limited thereto. Specifically, in some example implementations, the network entity 110 may communicate with multiple UEs, the UE 120 may communicate with multiple network entities, the network entity 110 and UE 120 may communicate with each other via an intermediate node/terminal, and the like, without departing from the scope of the present disclosure. Descriptions of an example environment that may implement the network entity 110 and UE 120 are provided below with reference to FIG. 8.

Further, it is contemplated that the network entity 110 and UE 120 may communicate and interoperate with each other to implement various methods and operations, in addition to those described above. For instance, as further described below with reference to FIG. 2 to FIG. 6, the network entity 110 and UE 120 may communicate and interoperate with each other to implement various methods and operations for addressing the shortcomings of the related art in each of the above-mentioned aspects (1) to (4).

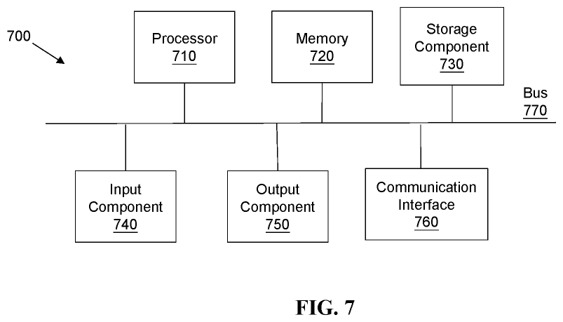

Furthermore, it is contemplated that the network entity 110 and UE 120 may further include components that may be configured to implement the associated functionalities or operations. Descriptions of various example components that may be included in (or may be configured to implement) the network entity 110 and/or UE 120 are provided below with reference to FIG. 7.

### Example Methods and Operations

Several example methods and operations, according to one or more example embodiments, are described below with reference to FIG. 2 to FIG. 6. One or more features, parameters, messages, and operations associated with FIG. 2 to FIG. 6 may be similar to those described above with reference to FIG. 1, and redundant descriptions associated therewith may be omitted below for conciseness.

For descriptive purposes, the example methods and operations may be mainly described herein as being performed by one or more specific entities, although it can be understood that, in actual implementations, another related network entity(s) and/or the UE may perform similar/related operations, without departing from the scope of the present disclosure. For instance, an operation of a network entity (e.g., network entity 110) receiving a data/message from a UE (e.g., UE 120) may suggest or indicate an operation of the UE providing the data/message to the network entity, an operation of the network entity providing a data/message that includes data/information that enables the UE to implement an operation/function may suggest or indicate an operation of the UE receiving the data/message and utilize the data/information included therein to implement the operation/function, and the like.

According to example embodiments, one or more operations of the network entity (e.g., base station, NG-RAN, core network, etc.) may be implemented in one or more apparatuses or hardware components. For instance, the network entity (or one or more associated operations) may be implemented in an apparatus/device that includes a processor and a memory storage (or any other suitable storage mediums), wherein the memory storage may include computer-executable instructions which, when executed by the processor, cause the processor to perform one or more operations thereof. An example device/apparatus that may implement the network entity (or one or more associated operations) is further described below with reference to FIG. 7.

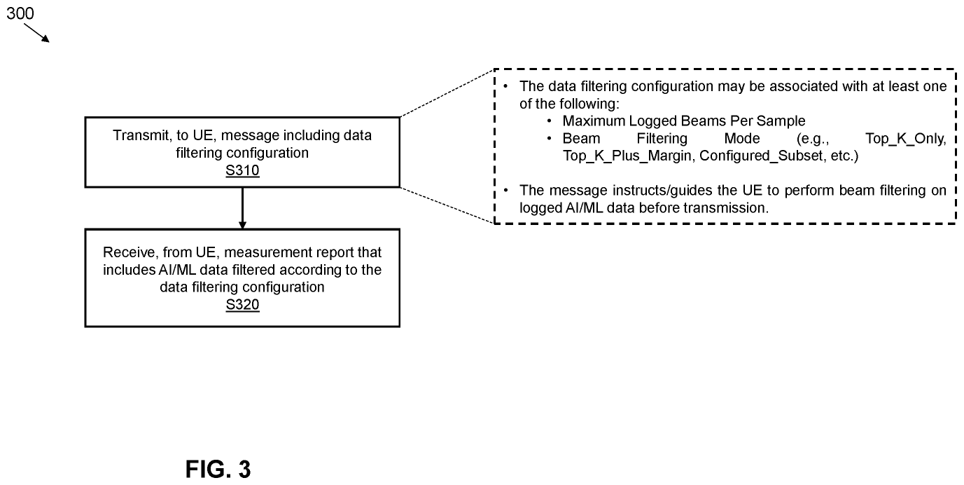

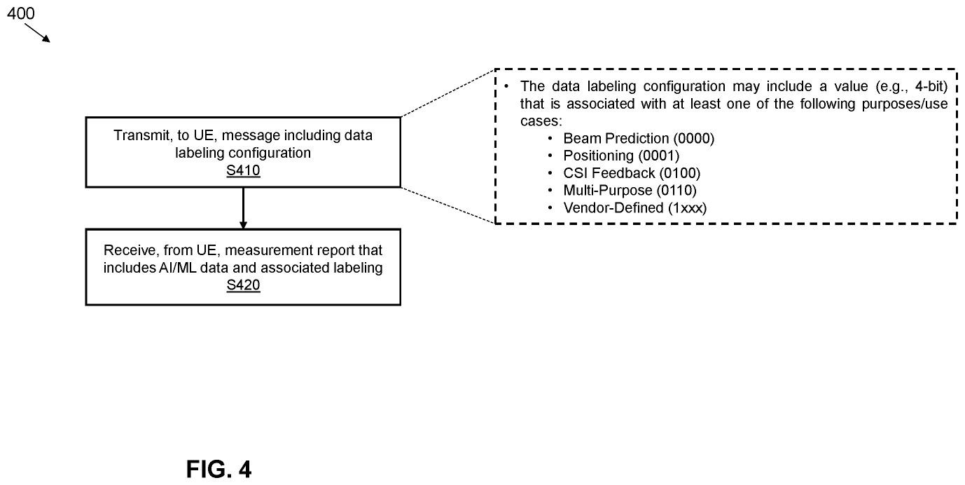

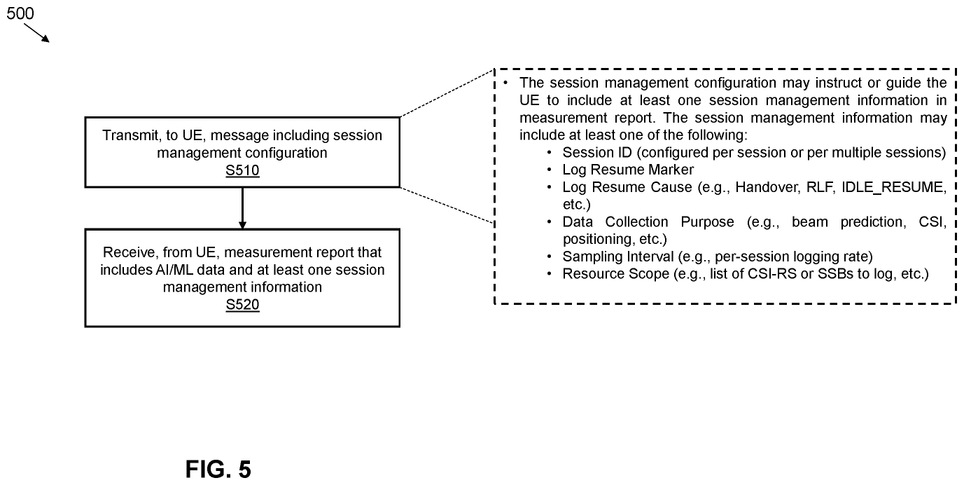

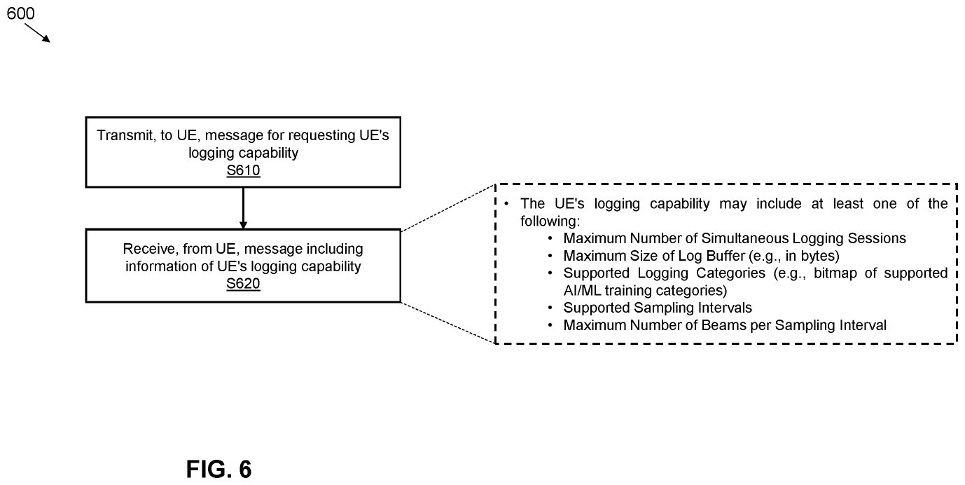

The example methods and operations in FIG. 2 to FIG. 6 may be implemented by the network entity to effectively and efficiently enhance NW-side AI/ML data management, thereby addressing the above-mentioned shortcomings of aspects (1) to (4). Generally, the example method and operations in FIG. 2 may be associated with aspect (1), the example method and operations in FIG. 3 may be associated with aspect (2), the example method and operations in FIG. 4 may be associated with aspect (3), and the example methods and operations in FIG. 5 and FIG. 6 may be associated with aspect (4).

In this regard, although some of the methods and operations may be described separately from one another, it is contemplated that, in some example implementations, the methods and operations in two or more of FIG. 2 to FIG. 6 may be implemented by the same network entity. In this regard, it can be understood that the network entity may perform multiple methods and operations in two or more of FIG. 2 to FIG. 6 in any suitable manner (e.g., simultaneously, sequentially, etc.) and may achieve the associated technical advantages in combination. By way of a non-limiting example, although the methods and operations in FIG. 2 and FIG. 3 are associated with different aspects (and thus, are described independently from each other herein), it can be understood that the network entity may be configured to implement the methods/operations in FIG. 2 and FIG. 3 in any suitable manner (e.g., simultaneously, sequentially, etc.) to thereby address the shortcomings of both aspect (1) and aspect (2) and achieve the technical advantages of addressing the shortcomings of both aspect (1) and aspect (2). Further, it can be understood that one or more operations in one of the FIG. 2 to FIG. 6 may be similar to or be part of one or more operations in another one of the FIG. 2 to FIG. 6. By way of a non-limiting example, the operations in FIG. 2 (e.g., operations associated with aspect (1), etc.) may involve one or more operations in FIG. 3 (e.g., operations associated with aspect (2), etc.), one or more operations in FIG. 5 may involve or be part of one or more operations in FIG. 6, and the like. Thus, it can be understood that the descriptions of an operation with reference to one of the FIG. 2 to FIG. 6 may be applicable to another operation of another one of the FIG. 2 to FIG. 6 without departing from the scope of the present disclosure, and redundant descriptions associated therewith may be omitted below for conciseness.

Further, the methods and operations in two or more of FIG. 2 to FIG. 6 may involve the collection of data associated with one or more AI/ML models. In this regard, it can be understood that the collected data may be utilized by the network entity for NW-side AI/ML purposes (e.g., training/fine-tuning one or more AI/ML models, inputting to one or more AI/ML models for inference purpose, providing AI/ML-related services, etc.), and the contents, characteristics, and intents of the collected data may be similar to the “AI/ML data,” “data collected for NW-side AI/ML purposes,” and the like, described above. Thus, it can also be understood that the characteristic and content of the data collected via the method and operations in one of FIG. 2 to FIG. 6 may be applicable to the data collected via the method and operations in another one of FIG. 2 to FIG. 6, and redundant descriptions associated therewith may be omitted for conciseness. Similarly, it can be understood that the characteristic and content of the messages or signals (e.g., RRC message, MAC CE, request message, etc.) involved in the method and operations of one of FIG. 2 to FIG. 6 may be applicable to the messages or signals involved operations in the method and operations of another one of FIG. 2 to FIG. 6, and redundant descriptions associated therewith may be omitted for conciseness.

### Example Methods and Operations Associated with Aspect (1)

FIG. 2 illustrates an example method 200, according to one or more example embodiments. The operations in method 200 may be performed by a network entity (e.g., network entity 110) to communicate with a UE (e.g., UE 120) to manage or configure one or more logging entry structures for NW-side AI/ML purposes.

As illustrated in FIG. 2, at operation S210, the network entity may be configured to transmit, to the UE, a message including a configuration associated with a data logging session (e.g., a data logging session for collecting data associated with an AI/ML model, etc.). Specifically, the configuration may be associated with at least one of: (a) a logging entry structure that indicates a content of data to be logged by the UE, or (b) a logging sampling interval for logging the data.

According to example embodiments, the logging entry structure may include at least one of: (a) a field indicating a time of measurement, (b) a field indicating an identifier (ID) of a resource measured by the UE, (c) a field indicating a power level measured on the resource, (d) a field indicating an ID associated with a beam resolved by the UE during the data logging session, or (e) a field indicating an ID associated with the configuration of the message transmitted by the network entity to the UE. According to example embodiments, the resource that may be measured by the UE may include at least one of: a channel state information reference signal (CSI-RS) resource, or a synchronization signal block (SSB) resource. Additionally or alternatively, the power level measured on the resource may include a Layer 1 reference signal received power (L1-RSRP). An example logging entry structure, according to one or more example embodiments, may define the following fields in Table 1 per log entry:

TABLE 1
Example Fields of Logging Entry Structure

| Field | Description |
|---|---|
| Timestamp | Time of measurement (in ms or system SFN) |
| CSI-RS/ | Identifier of the measured resource |
| SSB Resource ID | |
| L1-RSRP | Power level measured on the resource |
| Beam ID (optional) | Physical beam identifier if resolvable by the UE |
| Config Reference ID | Associated CSI-ReportConfig ID |
| | (or MeasObject ID) |

According to example embodiments, the data logging session may be associated with (or involve) data logging for positioning AI/ML model training (or any other suitable operations associated with any suitable types of LMF-side positioning model or downlink positioning reference signal (DL-PRS) logging), and the logging entry structure may include at least one of: (a) a field indicating an ID associated with a positioning reference signal (PRS) resource, (b) a field indicating a timing offset, (c) a field indicating a signal quality on the PRS resource, (d) a field indicating an ID associated with a transmission reception point (TRP), or (e) a field indicating a timestamp. According to example embodiments, the timing offset may include a reference signal time difference (RSTD). Additionally or alternatively, the signal quality may include at least one of: a reference signal received power (RSRP), or a signal to interference plus noise ratio (SINR). Additionally or alternatively, the ID associated with the TRP may include at least one of: a cell ID or a physical cell identity (PCI). Additionally or alternatively, the timestamp may include at least one of: a system frame number (SFN) or an identifier (ID) associated with a subframe. An example logging entry structure associated with DL-PRS, according to one or more example embodiments, may define the following fields in Table 2:

TABLE 2
Example Fields of DL-PRS Logging Entry Structure

| Field | Description |
|---|---|
| PRS Resource ID | Identifier for the DL-PRS instance |
| Timing Offset | RSTD or equivalent timing delta |
| Signal Quality | RSRP or SINR on PRS resource |
| TRP ID (Optional) | Optional; TRP/Cell ID or PCI |
| Timestamp | Sampling time (SFN or subframe aligned) |

According to example embodiments, the logging entry structure may include a field configured to carry data formatted according to a definition associated with a vendor of the UE. For instance, the field may be a specialized but optional field within the logging entry structure that enables the vendor to include proprietary, non-standardized information (e.g., modem-specific information, preprocessed metrics, intermediate inference results, etc.) in the logged AI/ML data. Namely, this field may act as a self-identifying vendor extension container reserved for custom/vendor-specific information or parameters that are understood only by network entities, devices, or software associated with the vendor and may be ignored by other entities that do not recognize the field and the associated content.

According to example embodiments, the logging sampling interval may include at least one of: a parameter indicating that the UE shall perform one sampling per channel state information reference signal (CSI-RS) transmission, a parameter indicating that the UE shall perform the data logging session every 20 milliseconds (ms), or a parameter indicating that the UE shall perform the data logging session every 80 ms. An example logging sampling interval, according to one or more example embodiments, may include the following parameters in Table 3:

TABLE 3
Example Parameters of Logging Sampling Interval

| Parameter | Description |
|---|---|
| alignWithCSI RS | One sample per CSI-RS transmission |
| fixed_20 ms | Log every 20 ms |
| fixed_80 ms | Log every 80 ms (etc., as needed by network) |

According to example embodiments, the message (that may be transmitted by the network entity to the UE at operation S210) may include a Radio Resource Control (RRC) message. In this regard, the RRC message may include an RRC Configuration/Reconfiguration message, such as: an RRC Connection Setup message, an RRC Connection Reconfiguration message, an RRC Connection Reestablishment message, and the like. In this regard, the configuration associated with the data logging session (e.g., configuration of the logging entry structure(s), configuration of the logging sampling interval, etc.) may be included in one or more Information Elements (IEs) of the RRC message. Alternatively or additionally, the message (that may be transmitted by the network entity to the UE at operation S210) may include a Medium Access Control (MAC) Control Element (CE). In this regard, the configuration associated with the data logging session (e.g., configuration of the logging entry structure(s), configuration of the logging sampling interval, etc.) may be implemented as a payload of the MAC CE that defines the intended configuration (e.g., X bits payload indicates logging entry structure configuration X and/or logging sampling interval X, etc.).

According to example embodiments, the message (that may be transmitted by the network entity to the UE at operation S210) may further include information or instructions that guide the UE on how to transmit the collected/logged data back to the network entity. Specifically, the message may include information or instructions that guide the UE to include AI/ML-relevant identifiers or information into one or more existing responding or reporting mechanisms. For instance, the message may further include information/instructions that guide the UE to extend a container of a Minimization of Drive Tests (MDT) measurement report (may be referred to as “LoggedMeasurementReport” herein) to include the logged data or content into the associated field(s) of the logging entry structure (e.g., adding the new fields as specified in the message to the standard MDT measurement report), thereby enabling the UE to include the specific data needed for NW-side AI/ML-operations when sending the MDT measurement report. As another example, the message may further include information/instructions that guide the UE to extend a response message (e.g., measurement report, etc.) (may be referred to as “UEInformationResponse” herein) to include a list of logging entry records (may be referred to as “DLPRSLoggingEntry records” herein) with an associated parameter (e.g., a tag/label that indicates that the purpose of the response message or the associated logging entry records are associated with the positioning model training, etc.). In this way, by implementing example embodiments, the existing responding or reporting mechanisms may be reused when possible while adding AI/ML-relevant identifiers as needed.

According to example embodiments, the message (that may be transmitted by the network entity to the UE at operation S210) may further include information or instructions that guide the UE on how to configure the logging sampling interval. For instance, the message may further include information or instructions that guide the UE to implement “CSI-RS alignment” as a default logging sampling interval, thereby establishing a default UE behavior where the data logging sampling automatically aligns with CSI-RS periodicity in the absence of a specific logging sampling interval configuration. In this way, example embodiments may support both fixed/default logging sampling intervals and alignment with CSI-RS periodicity, thereby providing a balance between consistency and configurability, and ensuring that the logged data/content may be inherently synchronized or aligned with the most relevant downlink signals (e.g., CSI-RS) for consistent AI/ML operations (e.g., model training, etc.).

Referring still to FIG. 2, at operation S220, the network entity may be configured to receive, from the UE, a measurement report associated with the data logging session. The measurement report may include at least one of: a log entry produced by the UE according to the logging entry structure, or data sampled by the UE according to the logging sampling interval. According to example embodiments, the measurement report may include an MDT measurement report (e.g., MDT's LoggedMeasurementReport, etc.). In this regard, one or more containers of the MDT measurement report may be extended (e.g., by the UE according to the configuration in the message provided by the network entity) to include one or more AI/ML-related identifiers or parameters (e.g., fields of the logging entry structure defined in the message provided by the network entity, etc.). Additionally or alternatively, the measurement report may include a list of DL-PRS logging entry records, each of which is tagged with the respective purpose (e.g., “dataCollectionPurpose=positioning”, etc.). Additionally or alternatively, the measurement report may include a field (e.g., “vendorExtensionContainer”, etc.) that is reserved for vendor use and may contain information or parameters that are interpretable by vendor-related entities and may be ignored by other unrelated entities that do not recognize the container (or the associated information).

In view of the above, the method and operations described herein introduce and exemplify a mechanism that may be implemented by a network entity (e.g., NG-RAN, etc.) to instruct or guide a UE to extend a logging entry structure and perform data sampling according to default/specified logging sampling interval, thereby efficiently and effectively addressing the shortcomings of aspect (1) as described above.

Advantageously, by implementing the method and operations described herein, the network entity may effectively and efficiently guide or instruct the UE to extend the logging entry structure to include one or more fields associated with AI/ML data (e.g., timestamps, resource identifiers, etc.) to resolve implementation ambiguity across different UEs, to include one or more fields associated with DL-PRS (e.g., PRS resource identifier, timing offset, etc.) to support LMF-side model training, and/or to include one or more fields associated with a vendor of the UE (e.g., vendor extension containers, etc.) to support self-identifying vendor-related information. Accordingly, the network entity may effectively and efficiently enhance AI/ML data logging content for improving implementability across different UEs, supporting DL-PRS logging, and managing extensibility for vendor use while preserving interoperability. Furthermore, the network entity may guide or instruct the UE to extend one or more existing reporting mechanisms (e.g., MDT measurement report, etc.), thereby ensuring that the AI/ML-relevant information or identifiers may be added while reusing the existing reporting mechanisms whenever possible. In addition, the network entity may effectively and efficiently enhance sampling behavior by guiding or instructing the UE to perform sampling according to default/specified logging sampling intervals, thereby providing a balance between data consistency and sampling interval configurability.

### Example Methods and Operations Associated with Aspect (2)

FIG. 3 illustrates an example method 300, according to one or more example embodiments. The operations in method 300 may be performed by a network entity (e.g., network entity 110) to communicate with a UE (e.g., UE 120) to implement beam filtering and granularity control for an AI/ML data logging for NW-side AI/ML purposes.

As illustrated in FIG. 3, at operation S310, the network entity may be configured to transmit, to the UE, a message including a configuration for filtering logged data before transmission (“data filtering configuration” herein). Hereinbelow, the configuration is described as associated with at least one of: (a) a maximum logged beams per sample, or (b) a beam filtering mode. It is contemplated that, in actual implementations, filtering of any other suitable data (in addition to or in alternative to beam measurement) may be configured in a similar manner, without departing from the scope of the present disclosure.

According to example embodiments, the message (that may be transmitted by the network entity to the UE at operation S310) may include an RRC message. In this regard, the RRC message may include an RRC Configuration/Reconfiguration message, such as: an RRC Connection Setup message, an RRC Connection Reconfiguration message, an RRC Connection Reestablishment message, and the like. In this regard, the data filtering configuration may be included in one or more IEs of the RRC message. Alternatively or additionally, the message (that may be transmitted by the network entity to the UE at operation S310) may include a MAC CE. In this regard, the data filtering configuration may be implemented as a payload of the MAC CE that defines the intended configuration (e.g., X bits payload indicates data filtering configuration X and/or beam filtering mode X, etc.).

According to example embodiments, the message (that may be transmitted by the network entity to the UE at operation S310) may further include information or instructions that guide the UE on how to filter the collected/logged data before transmitting the same to the network entity. Specifically, the message may include information or instructions that guide the UE to apply beam filtering based on the maximum logged beams per sample and/or the beam filtering mode.

According to example embodiments where the message is an RRC message, the configuration associated with the maximum logged beam per sample may be included in an IE (e.g., “maxLoggedBeamPerSample”, etc.) in the RRC message. The configuration may define a quantitative upper limit on the number of individual beam measurements the UE is permitted to retain in its memory buffer for any given sampling interval or a duration of time. By providing this configuration to the UE, the network entity may prevent the UE buffer from being overwhelmed in dense deployments containing dozens of reference signal resources (e.g., CSI-RS resources), ensuring that the UE records and subsequently reports only a manageable, bounded subset of beam measurements per sample rather than exhaustively logging all available beams, which ultimately optimizes both the UE's internal storage utilization and the computational efficiency of subsequent AI/ML model training pipelines.

According to example embodiments, the beam filtering mode may include at least one of: (a) a first mode (e.g., “topKOnly”, etc.) that indicates the UE shall retain only top-K beams by reference signal received power (RSRP), (b) a second mode (e.g., “topKPlusMargin”, etc.) that indicates the UE shall retain beams within a configurable delta (e.g., X dB, etc.) of the top beam, or (c) a third mode (e.g., “configuredSubset”, etc.) that indicates the UE shall log only beams explicitly identified by the network entity. An example beam filtering mode, according to one or more example embodiments, may include the following parameters in Table 4:

TABLE 4
Example Filtering Modes

| Filtering Mode | Description |
|---|---|
| topKOnly | Retain only top-K beams by RSRP |
| topKPlusMargin | Retain beams within X dB of top |
| | beam (configurable delta) |
| configuredSubset | Log only beams explicitly identified by the NW |

Referring still to FIG. 3, at operation S320, the network entity may be configured to receive, from the UE, a measurement report that includes AI/ML data filtered according to the data filtering configuration. According to example embodiments, the measurement report may include an MDT measurement report (e.g., MDT's LoggedMeasurementReport, etc.). In this regard, the measurement report may include AI/ML data (e.g., beam measurements, etc.) that have been filtered by the UE based on the maximum logged beams per sample and/or the beam filtering mode configured by the network entity. For instance, the measurement report may include only the top-K beams by RSRP, beams within a configurable margin of the top beam, or beams from a configured subset explicitly identified by the network entity, depending on the filtering mode specified in the data filtering configuration.

In view of the above, the method and operations described herein introduce and exemplify a mechanism that may be implemented by a network entity (e.g., NG-RAN, etc.) to instruct or guide a UE to perform beam filtering at the point of capture (e.g., prior to transmission or final logging), thereby constraining the logging data volume and improving the utility of the dataset for AI/ML training pipelines, efficiently and effectively addressing the shortcomings of aspect (2) as described above.

Specifically, the method of FIG. 3 enables the network entity to instruct the UE to perform data filtering at the point of capture (e.g., perform the filtering at the UE prior to transmission or final logging), thereby bounding the logging volume and improving the utility of the dataset for AI/ML training pipelines. By configuring the maximum number of logged beams per sample and the filtering mode, the network entity may ensure that the UE retains only the most relevant beam measurements (e.g., top-K beams by RSRP, beams within a configurable delta of the top beam, or beams explicitly identified by the network entity), while filtering low-value data that may otherwise overwhelm the UE buffer and degrade model utility.

Advantageously, by implementing the method and operations described herein, the network entity may effectively and efficiently guide or instruct the UE to constrain the number of beam measurements retained per sample using the maximum logged beams per sample parameter/configuration, apply beam filtering according to the configured filtering mode (e.g., retaining top-K beams by RSRP, retaining beams within a configurable margin of the top beam, or retaining only beams explicitly identified by the network entity), and/or perform the filtering at the point of capture to minimize the volume of low-value beam data. Accordingly, the network entity may effectively and efficiently enhance beam filtering and granularity control for AI/ML data logging, thereby avoiding AI/ML model utility degradation by focusing on dominant beams or those within a meaningful delta (e.g., within a threshold like 3 dB of the top beam, etc.) and reducing the amount of less-meaningful data that may otherwise overwhelm the UE buffer.

### Example Methods and Operations Associated with Aspect (3)

FIG. 4 illustrates an example method 400, according to one or more example embodiments. The operations in method 400 may be performed by a network entity (e.g., network entity 110) to communicate with a UE (e.g., UE 120) to configure data labeling for NW-side AI/ML purposes.

As illustrated in FIG. 4, at operation S410, the network entity may be configured to transmit, to the UE, a message including a data labeling configuration. Specifically, the data labeling configuration may include a value (e.g., a 4-bit value, etc.) that is associated with at least one of the following purposes or use cases: beam prediction, positioning, CSI feedback, multi-purpose, or vendor-defined. The data labeling configuration may include one or more indicators or parameters (e.g., integer, value, etc.) associated with different purposes or use cases. In some example embodiments, the data collection purpose indicator may include multiple values that indicate multiple purposes, and the data collection purpose indicator may be presented in a table form. An example data collection purpose indicator, according to one or more example embodiments, may include the following values in Table 5:

TABLE 5
Example Data Collection Purpose Indicators

| Value | Purpose |
|---|---|
| 0000 | Beam Prediction |
| 0001 | Positioning |
| 0100 | CSI Feedback |
| 0110 | Multi-Purpose |
| 1xxx | Vendor-defined |

According to example embodiments, the message (that may be transmitted by the network entity to the UE at operation S410) may include an RRC message. In this regard, the RRC message may include an RRC Configuration/Reconfiguration message, such as: an RRC Connection Setup message, an RRC Connection Reconfiguration message, an RRC Connection Reestablishment message, and the like. In this regard, the data labeling configuration may be included in one or more IEs of the RRC message. Alternatively or additionally, the message (that may be transmitted by the network entity to the UE at operation S410) may include a MAC CE. In this regard, the data labeling configuration may be implemented as a payload of the MAC CE that defines the intended configuration (e.g., X bits payload indicates data labeling configuration X, etc.).

According to example embodiments, the message (that may be transmitted by the network entity to the UE at operation S410) may further include information or instructions that guide the UE on how to tag or categorize the collected data according to its intended purpose or use case. Specifically, the message may include information or instructions that guide the UE to include a data collection purpose indicator (e.g., “dataCollectionPurpose”, etc.) in the logged data and/or measurement reports. As exemplified in Table 4, the data collection purpose indicator may include a 4-bit value that indicates the intended training category or use case of the collected data. In this regard, by including the data collection purpose indicator in the logged data and/or measurement reports, the UE may explicitly tag or indicate the intention of the collected dataset, thereby ensuring that the collected data is correctly routed to the compatible and associated AI/ML model pipeline and preventing the ingestion of mismatched or incompatible data types.

Referring still to FIG. 4, at operation S420, the network entity may be configured to receive, from the UE, a measurement report that includes AI/ML data and associated labeling. The measurement report may contain data collected by the UE along with the labeling information configured in operation S410, thereby enabling the network entity to correctly route the received data to the appropriate AI/ML model pipeline based on the associated purpose or use case. According to example embodiments, the measurement report may include an MDT measurement report (e.g., MDT's LoggedMeasurementReport, etc.) or a UE information response message (e.g., UEInformationResponse, etc.). In this regard, the measurement report may include the data collection purpose indicator that tags or categorizes the collected AI/ML data according to the configuration provided by the network entity.

In view of the above, the method and operations described herein introduce and exemplify a mechanism that may be implemented by a network entity (e.g., NG-RAN, etc.) to instruct or guide a UE to tag or categorize collected data according to its intended purpose or use case, thereby providing a mechanism for dataset purpose tagging and multi-use case labeling, efficiently and effectively addressing the shortcomings of aspect (3) as described above.

Specifically, the method of FIG. 4 enables the network entity to instruct the UE to include a data collection purpose indicator in the logged data and/or measurement reports, thereby ensuring that the collected data is properly categorized and routed to compatible model pipelines. By configuring the data labeling configuration, the network entity may ensure that the UE explicitly tags the collected dataset with its intended training category or use case (e.g., beam prediction, positioning, CSI feedback, multi-purpose, or vendor-defined), preventing the ingestion of mismatched or incompatible data types during AI/ML operations such as model training or inference.

Advantageously, by implementing the method and operations described herein, the network entity may effectively and efficiently guide or instruct the UE to tag or categorize collected data according to its intended purpose or use case using the data collection purpose indicator, include the labeling information in logged data and measurement reports, and ensure correct routing of the collected data to compatible AI/ML model pipelines. Accordingly, the network entity may effectively and efficiently enhance dataset purpose tagging and multi-use case labeling for AI/ML data logging, thereby preventing the misrouting of logged data to incompatible models and avoiding poor accuracy or training failure that may result from the ingestion of mismatched data types.

### Example Methods and Operations Associated with Aspect (4)

FIG. 5 illustrates an example method 500, according to one or more example embodiments. The operations in method 500 may be performed by a network entity (e.g., network entity 110) to communicate with a UE (e.g., UE 120) to manage session information for NW-side AI/ML purposes.

As illustrated in FIG. 5, at operation S510, the network entity may be configured to transmit, to the UE, a message including a session management configuration. Specifically, the session management configuration may instruct or guide the UE to include at least one session management information in a measurement report (e.g., MDT report, RRC report, etc.). The session management information may include at least one of: (a) a session identifier (ID) configured per session or per multiple sessions, (b) a log resume marker (e.g., an indicator that marks a point of resumption within an ongoing data logging session performed before a mobility event such as handover, radio link failure (RLF), connection resumption from RRC_IDLE state, etc.), (c) a log resume cause (e.g., an indicator that indicates the cause of the resumption of the data logging session, such as “Handover”, “RLC”, “IDLE_RESUME”, etc.), (d) a data collection purpose (e.g., beam prediction, CSI, positioning, etc.), (e) a sampling interval indicating a per-session logging rate, or (f) a resource scope indicating a list of resources (e.g., CSI-RS, SSBs, etc.) to log.

According to example embodiments, the message (that may be transmitted by the network entity to the UE at operation S510) may include an RRC message. In this regard, the RRC message may include an RRC Configuration/Reconfiguration message, such as: an RRC Connection Setup message, an RRC Connection Reconfiguration message, an RRC Connection Reestablishment message, and the like. In this regard, the session management configuration may be included in one or more IEs of the RRC message. Alternatively or additionally, the message (that may be transmitted by the network entity to the UE at operation S510) may include a MAC CE. In this regard, the session management configuration may be implemented as a payload of the MAC CE that defines the intended configuration.

According to example embodiments, the session management configuration may enable the network entity to configure and manage multiple AI/ML logging sessions concurrently. For instance, the session management configuration may define a logging configuration set (e.g., “LoggingConfigurationSet”, etc.) that allows configuration of multiple logging sessions, each with at least one of: a unique session ID, a data collection purpose, a sampling interval, or a resource scope. In this regard, by configuring multiple logging sessions with distinct purposes and parameters, the network entity may effectively support scenarios where the UE is logging data for multiple AI/ML use cases simultaneously (e.g., beam power data for gNB-side model training, PRS measurements for LMF-side positioning model training, CSI feature sets for channel reconstruction models, etc.). An example session management information, according to one or more example embodiments, may include the following fields in Table 6:

TABLE 6
Example Session Management Information

| Field | Description |
|---|---|
| Session ID | Unique identifier for this configuration |
| dataCollectionPurpose | Tag for beam prediction, CSI, positioning |
| Sampling Interval | Per-session logging rate |
| Resource Scope | List of CSI-RS/SSBs to log, |

Table 7 below illustrates an example use case of session management configuration that may enable the network entity to configure and manage two AI/ML logging sessions concurrently:

TABLE 7
Example Use Case of Session Management Information

| Session ID | Purpose | Interval | Scope |
|---|---|---|---|
| 0x01 | Beam Prediction | 40 ms | Set A beams |
| 0x02 | Positioning | 80 ms | DL-PRS list |

Referring still to FIG. 5, at operation S520, the network entity may be configured to receive, from the UE, a measurement report that includes AI/ML data and at least one session management information. The measurement report may contain data collected by the UE along with the session management information configured in operation S510, thereby enabling the network entity to track session continuity and manage multiple logging sessions. According to example embodiments, the measurement report may include an MDT measurement report (e.g., MDT's LoggedMeasurementReport, etc.), a UE information response message (e.g., UEInformationResponse, etc.), or a UE assistance information message (e.g., UEAssistanceInformation, etc.). In this regard, the measurement report may include per-session report flags and availability indication, enabling the network entity to identify which logging sessions have available data and to retrieve the data accordingly.

According to example embodiments, the UE may be configured to insert a log resume marker in the logs after mobility events (e.g., RLF, handover, etc.), optionally with a cause indication (e.g., HO, RLF, IDLE_RESUME, etc.). In this regard, by including the session ID and the log resume marker in the logs and reporting messages, the network entity may effectively track session continuity and resume sessions after mobility events, thereby avoiding ambiguous or duplicated datasets. This mechanism supports AI pipelines where datasets must be stitched together and session-aware for time-sequence learning.

In view of the above, the method and operations described herein with reference to FIG. 5 introduce and exemplify a mechanism that may be implemented by a network entity (e.g., NG-RAN, etc.) to instruct or guide a UE to manage session information for AI/ML data logging, thereby enabling session tracking across mobility events and supporting multiple concurrent logging sessions, efficiently and effectively addressing the shortcomings of aspect (4) as described above.

FIG. 6 illustrates an example method 600, according to one or more example embodiments. The operations in method 600 may be performed by a network entity (e.g., network entity 110) to request and receive UE logging capability information for NW-side AI/ML data management purposes.

As illustrated in FIG. 6, at operation S610, the network entity may be configured to transmit, to the UE, a message for requesting the UE's logging capability. This message enables the network entity to query the UE regarding its logging-related limitations and supported features. According to example embodiments, the message may include a UE capability enquiry message or any other suitable message that requests the UE to report its logging capability.

At operation S620, the network entity may be configured to receive, from the UE, a message including information of the UE's logging capability. The UE's logging capability may include at least one of: (a) a maximum number of simultaneous logging sessions, (b) a maximum size of log buffer (e.g., in bytes), (c) supported logging categories (e.g., a bitmap of supported AI/ML training categories), (d) supported sampling intervals, or (e) a maximum number of beams per sampling interval.

An example UE logging capability, according to one or more example embodiments, may include the following fields in Table 8:

TABLE 8
Example UE Capability

| Capability Field | Description |
|---|---|
| maxConcurrentLoggingSessions | Maximum number of simultaneous |
| | logging sessions |
| loggingBufferSizeBytes | Max size of log buffer |
| supportedLoggingCategories | Bitmap of AI/ML training |
| | categories supported |
| supportedSamplingIntervals | List of supported sampling intervals |
| maxBeamsPerSample | Max number of beams per |
| | sampling interval |

In view of the above, the method and operations described herein with reference to FIG. 6 introduce and exemplify a mechanism that may be implemented by a network entity (e.g., NG-RAN, etc.) to request and receive UE logging capability information, thereby enabling the network entity to adapt logging strategies based on UE capacity and capabilities, efficiently and effectively addressing the shortcomings of aspect (4) as described above.

Specifically, the method of FIG. 6 enables the network entity to query the UE's logging-related limitations upfront, thereby avoiding over-configuration and failure to capture datasets for NW-side AI/ML purposes. By obtaining the UE's logging capability information (e.g., maximum number of simultaneous logging sessions, maximum size of log buffer, supported logging categories, supported sampling intervals, maximum number of beams per sampling interval, etc.), the network entity may configure logging sessions that are within the UE's capabilities, ensuring successful data collection for AI/ML operations.

Advantageously, by implementing the methods and operations described herein with reference to FIG. 5 and FIG. 6, the network entity may effectively and efficiently enhance session management and interruption recovery for AI/ML data logging. Specifically, the network entity may guide or instruct the UE to include session management information (e.g., session ID, log resume marker, log resume cause, etc.) in logs and measurement reports, thereby enabling session tracking across mobility events and supporting the re-assembly of fragmented sessions for time-sequence learning. Furthermore, the network entity may query and receive the UE's logging capability information, thereby adapting logging strategies based on UE capacity and avoiding over-configuration. Accordingly, the network entity may effectively and efficiently address the shortcomings of aspect (4), including session continuity tracking, interruption recovery, logging capability advertisement, and multi-session logging support.

### Summary

In view of the above, FIG. 2 to FIG. 6 illustrate various example methods and operations that may be implemented to address the shortcomings of the above-described aspects (1)-(4), thereby enabling effective and efficient enhancement on NW-side AI/ML data management.

It is contemplated that the methods, operations, advantages, and significances described above with reference to FIG. 2 to FIG. 6 are merely examples, and the scope of the present disclosure should not be limited thereto. Specifically, one or more operations in FIG. 2 to FIG. 6 may be performed differently, less or additional operations may be involved, the messages or commands involved therein may include less or additional parameters, additional technical advantages may be achieved, and the like, without departing from the scope of the present disclosure. Further, it is contemplated that one or more of the above-described parameters, messages, and the like, may be consistent with those specified in one or more standard specifications, with additional parameters, attributes, and mechanisms supplemented thereto (when required). Further, multiple methods and operations in FIG. 2 to FIG. 6 may be performed in combination with each other, without departing from the scope of the present disclosure.

### Examples of Device

One or more components of the example embodiments (e.g., network entity, UE, etc.), as well as the operations associated therewith, may be implemented in one or more devices or hardware components. For instance, one or more components/operations of the network entity may be implemented in one or more devices like a server(s), and the like.

In the following, descriptions of a device in which the example embodiments may be implemented are provided. It is contemplated that one or more features, operations, and methods described above may be performed by the device. For instance, the one or more operations or methods associated with the network entity may be performed by at least one processor of the device upon executing machine-readable instructions or computer-readable instructions stored in a memory or a storage component of the device.

FIG. 7 illustrates an embodiment of a device 700. As shown in FIG. 7, the device 700 may include a processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 cause the processor 710 to perform one or more method steps of an embodiment described above.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, instructions to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of devices 700 in communication with one another.

### Example Implementation Environment

Example embodiments of the present disclosure may be implemented in any suitable type of environment. In the following, an example environment (in which the example embodiments may be implemented) is described.

FIG. 8 illustrates a diagram of an example environment 800 in which systems and/or methods, described herein, may be implemented. The implementation environment 800 includes a UE (User equipment) 810, a service environment 820, and a network 830. The service environment 820 includes one or more sub-environments 821. To illustrate this, FIG. 8 shows, for convenience, examples of a 1st sub-environment 821-1, a 2nd sub-environment 821-2, and an N-th sub-environment 821-N (where N is any natural number).

The UE 810 is connected to the network 830, and the network 830 is connected to the service environment 820. The connections may be wired, wireless, or a combination of both wired and wireless. The UE 810 and the service environment 820 are connected via the network 830.

The UE 810 is a device that communicates with the service environment 820. The UE 810 receives information from the service environment 820 and/or sends information to the service environment 820. Also, the UE 810 may generate and/or store information to be transmitted, as necessary. Also, the UE 810 may store and/or process information that is received, as necessary.

The example FIG. 8 refers to the “UE”. However, it should be understood by those skilled in the art that general terms such as “user device,” “terminal,” “terminal device,” “communication device,” and “communication terminal” can be used interchangeably with the term “UE.”

For example, the UE 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 820 is an environment that communicates with the UE 810 to provide one or more services. The service environment 820 receives information from the UE 810 and/or sends information to the UE 810. Also, the service environment 820 may generate and/or store information to be transmitted, as necessary. Also, the service environment 820 may store and/or process information that is received, as necessary. For example, the service environment 820 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 8 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 820 is not specifically limited and can be adjusted according to the embodiments. For example, the services may include a service that provides information to the UE 810, a service that stores information from the UE 810, or a service that performs processing based on information from the UE 810 and returns the results of the processing.

In an embodiment, the Service Environments 820 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 820 includes one or more devices, such as servers and network devices, which provide services or perform processes. The placement of these devices within the service environment 820 can be determined as appropriate. Additionally, if the service environment 820 includes one or more sub-environments 821, the placement of devices can be determined based on predetermined policies for each sub-environment 821. For example, devices related to the first service may be placed in the 1st sub-environment 821-1, and devices related to the second service may be placed in the 2nd sub-environment 821-2. In another example, devices expected to have a higher load than a predetermined threshold may be placed in the 1st sub-environment 821-1, while devices expected to have a lower load than the predetermined threshold may be placed in the 2nd sub-environment 821-2. In this way, specific devices can be placed in specific sub-environments 821. Conversely, each sub-environment 821 can be specialized for a particular purpose.

In an embodiment, all processes executed in a single service may run within a single service environment, or in multiple service environments. Multiple processes executed in a single service could be provided by different service environments.

The network 830 is a network that exchanges information between the UE 810 and the service environment 820. The network 830 includes one or more wired and/or wireless networks.

For example, the network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 830 can be a part of a network. For example, in a 5G network that includes a RAN, a transport network, and a core network, the network 830 can be at least one of the RAN, the transport network, or the core network. For example, the service environment 820 could be in the core network, in which case the network 830 could correspond to a network that is a combination of a RAN and a transport network and is part of the 5G network.

In this regard, the UE 810 in FIG. 8 may be similar to the UE 120 in FIG. 1, while the network entity 110 in FIG. 1 may be implemented in the network 830. Further, the AI/ML-related operations described herein (e.g., AI/ML model training, AI/ML inference, etc.) may be implemented in the service environment 820.

The number and arrangement of devices and networks shown in FIG. 8 are provided as an example. It should be understood that any changes that may be implemented by those skilled in the art, such as the addition or rearrangement of well-known devices or networks at the time of implementation, are included in this disclosure.

### Various Aspects of Embodiments

Example embodiments introduces new parameters, attributes, mechanisms, and features that supplement and enhance the disclosures of one or more standard specifications. As a non-limiting example, example embodiments supplement and enhance at least one technical documents associated with 3GPP Technical Specification Group-Radio Access Network (TSG-RAN) Working Group 2 (WG2). Specifically, the following disclosures were introduced by the example embodiments of the present disclosure during the 3GPP TSG-RAN WG2 Meeting #129bis:

In view of the above, example embodiments introduce clarified, specified, and standardized approaches for enhancing the management of NW-side AI/ML data in the 3GPP-based network architecture. Specifically, example embodiments clarify how specifically the 3GPP defined frameworks and architectures (e.g., MDT, RRC signaling, MAC CE signaling, etc.) can be utilized to enhance the management of the NW-side AI/ML data. Accordingly, the example embodiments may be implemented in the 3GPP-based networks in a clear and standardized manner.

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system comprising: a network entity configured to: transmit, to a user equipment (UE), a message comprising a configuration associated with a data logging session for collecting data associated with an Artificial Intelligence or Machine Learning (AI/ML) model, wherein the configuration is associated with at least one of: a logging entry structure that indicates a content of data to be logged by the UE, or a logging sampling interval for logging the data; and receive, from the UE, a measurement report associated with the data logging session, wherein the measurement report comprises at least one of: a log entry produced by the UE according to the logging entry structure, or data sampled by the UE according to the logging sampling interval.
Item [2]: The system according to item [1], the logging entry structure comprises at least one of: a field indicating a time of measurement, a field indicating an identifier (ID) of a resource measured by the UE, a field indicating a power level measured on the resource, a field indicating an ID associated with a beam resolved by the UE during the data logging session, or a field indicating an ID associated with the configuration of the message transmitted by the network entity to the UE.
Item [3]: The system according to item [2], wherein the resource comprises at least one of: a channel state information reference signal (CSI-RS) resource or a synchronization signal block (SSB) resource.
Item [4]: The system according to one or more of items [2]-[3], wherein the power level comprises a Layer 1 reference signal received power (L1-RSRP).
Item [5]: The system according to one or more of items [1]-[4], wherein the measurement report comprises a minimization of drive tests (MDT) measurement report
Item [6]: The system according to one or more of items [1]-[5], the logging sampling interval comprises at least one of: a parameter indicating that the UE shall perform one sampling per channel state information reference signal (CSI-RS) transmission, parameter indicating that the UE shall perform the data logging session every 20 milliseconds (ms), or a parameter indicating that the UE shall perform the data logging session every 80 milliseconds (ms).
Item [7]: The system according to one or more of items [1]-[6], wherein the logging entry structure comprises at least one of: a field indicating an identifier (ID) associated with a positioning reference signal (PRS) resource, a field indicating a timing offset, a field indicating a signal quality on the PRS resource, a field indicating an ID associated with a transmission reception point (TRP), or a field indicating a timestamp.
Item [8]: The system according to item [7], wherein the timing offset comprises a reference signal time difference (RSTD).
Item [9]: The system according to one or more of items [7]-[8], wherein the signal quality comprises at least one of: a reference signal received power (RSRP) or a signal to interference plus noise ratio (SINR).
Item [10]: The system according to one or more of items [7]-[9], wherein the ID associated with the TRP comprises at least one of: a cell ID or a physical cell identity (PCI).
Item [11]: The system according to one or more of items [7]-[10], wherein the timestamp comprises at least one of: a system frame number (SFN) or an identifier (ID) associated with a subframe.
Item [12]: The system according to one or more of items [1]-[11], wherein the measurement report comprises a parameter indicating that the log entry is associated with a positioning AI/ML model.
Item [13]: The system according to one or more of items [1]-[12], wherein the message comprises a radio resource control (RRC) message.
Item [14]: The system according to one or more of items [1]-[13], wherein the logging entry structure comprises a field configured to carry data formatted according to a definition associated with a vendor of the UE.
Item [15]: A method comprising: transmitting, by a network entity and to a user equipment (UE), a message comprising a configuration associated with a data logging session for collecting data associated with an Artificial Intelligence or Machine Learning (AI/ML) model, wherein the configuration is associated with at least one of: a logging entry structure that indicates a content of data to be logged by the UE, or a logging sampling interval for logging the data; and receiving, by the network entity and from the UE, a measurement report associated with the data logging session, wherein the measurement report comprises at least one of: a log entry produced by the UE according to the logging entry structure, or data sampled by the UE according to the logging sampling interval.
Item [16]: The method according to item [15], wherein the logging entry structure comprises at least one of: a field indicating a time of measurement, a field indicating an identifier (ID) of a resource measured by the UE, a field indicating a power level measured on the resource, a field indicating an ID associated with a beam resolved by the UE during the data logging session, or a field indicating an ID associated with the configuration of the message transmitted by the network entity to the UE.
Item [17]: The method according to item [16], wherein the resource comprises at least one of: a channel state information reference signal (CSI-RS) resource or a synchronization signal block (SSB) resource.
Item [18]: The method according to one or more of items [16]-[17], wherein the power level comprises a Layer 1 reference signal received power (L1-RSRP).
Item [19]: The method according to one or more of items [15]-[18], wherein the measurement report comprises a minimization of drive tests (MDT) measurement report.
Item [20]: A non-transitory computer-readable recording medium having recorded thereon instructions executable by a network entity to cause the network entity to perform a method comprising: transmitting, to a user equipment (UE), a message comprising a configuration associated with a data logging session for collecting data associated with an Artificial Intelligence or Machine Learning (AI/ML) model, wherein the configuration is associated with at least one of: a logging entry structure that indicates a content of data to be logged by the UE, or a logging sampling interval for logging the data; and receiving, from the UE, a measurement report associated with the data logging session, wherein the measurement report comprises at least one of: a log entry produced by the UE according to the logging entry structure, or data sampled by the UE according to the logging sampling interval.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a network entity configured to:
transmit, to a user equipment (UE), a message comprising a configuration associated with a data logging session for collecting data associated with an Artificial Intelligence or Machine Learning (AI/ML) model, wherein the configuration is associated with at least one of: a logging entry structure that indicates a content of data to be logged by the UE, or a logging sampling interval for logging the data; and
receive, from the UE, a measurement report associated with the data logging session, wherein the measurement report comprises at least one of: a log entry produced by the UE according to the logging entry structure, or data sampled by the UE according to the logging sampling interval.

2. The system according to claim 1, wherein the logging entry structure comprises at least one of: a field indicating a time of measurement, a field indicating an identifier (ID) of a resource measured by the UE, a field indicating a power level measured on the resource, a field indicating an ID associated with a beam resolved by the UE during the data logging session, or a field indicating an ID associated with the configuration of the message transmitted by the network entity to the UE.

3. The system according to claim 2, wherein the resource comprises at least one of: a channel state information reference signal (CSI-RS) resource or a synchronization signal block (SSB) resource.

4. The system according to claim 2, wherein the power level comprises a Layer 1 reference signal received power (L1-RSRP).

5. The system according to claim 1, wherein the measurement report comprises a minimization of drive tests (MDT) measurement report.

6. The system according to claim 1, wherein the logging sampling interval comprises at least one of: a parameter indicating that the UE shall perform one sampling per channel state information reference signal (CSI-RS) transmission, parameter indicating that the UE shall perform the data logging session every 20 milliseconds (ms), or a parameter indicating that the UE shall perform the data logging session every 80 milliseconds (ms).

7. The system according to claim 1, wherein the logging entry structure comprises at least one of: a field indicating an identifier (ID) associated with a positioning reference signal (PRS) resource, a field indicating a timing offset, a field indicating a signal quality on the PRS resource, a field indicating an ID associated with a transmission reception point (TRP), or a field indicating a timestamp.

8. The system according to claim 7, wherein the timing offset comprises a reference signal time difference (RSTD).

9. The system according to claim 7, wherein the signal quality comprises at least one of: a reference signal received power (RSRP) or a signal to interference plus noise ratio (SINR).

10. The system according to claim 7, wherein the ID associated with the TRP comprises at least one of: a cell ID or a physical cell identity (PCI).

11. The system according to claim 7, wherein the timestamp comprises at least one of: a system frame number (SFN) or an identifier (ID) associated with a subframe.

12. The system according to claim 1, wherein the measurement report comprises a parameter indicating that the log entry is associated with a positioning AI/ML model.

13. The system according to claim 1, wherein the message comprises a radio resource control (RRC) message.

14. The system according to claim 1, wherein the logging entry structure comprises a field configured to carry data formatted according to a definition associated with a vendor of the UE.

15. A method comprising:
transmitting, by a network entity and to a user equipment (UE), a message comprising a configuration associated with a data logging session for collecting data associated with an Artificial Intelligence or Machine Learning (AI/ML) model, wherein the configuration is associated with at least one of: a logging entry structure that indicates a content of data to be logged by the UE, or a logging sampling interval for logging the data; and
receiving, by the network entity and from the UE, a measurement report associated with the data logging session, wherein the measurement report comprises at least one of: a log entry produced by the UE according to the logging entry structure, or data sampled by the UE according to the logging sampling interval.

16. The method according to claim 15, wherein the logging entry structure comprises at least one of: a field indicating a time of measurement, a field indicating an identifier (ID) of a resource measured by the UE, a field indicating a power level measured on the resource, a field indicating an ID associated with a beam resolved by the UE during the data logging session, or a field indicating an ID associated with the configuration of the message transmitted by the network entity to the UE.

17. The method according to claim 16, wherein the resource comprises at least one of: a channel state information reference signal (CSI-RS) resource or a synchronization signal block (SSB) resource.

18. The method according to claim 16, wherein the power level comprises a Layer 1 reference signal received power (L1-RSRP).

19. The method according to claim 15, wherein the measurement report comprises a minimization of drive tests (MDT) measurement report.

20. A non-transitory computer-readable recording medium having recorded thereon instructions executable by a network entity to cause the network entity to perform a method comprising:
transmitting, to a user equipment (UE), a message comprising a configuration associated with a data logging session for collecting data associated with an Artificial Intelligence or Machine Learning (AI/ML) model, wherein the configuration is associated with at least one of: a logging entry structure that indicates a content of data to be logged by the UE, or a logging sampling interval for logging the data; and
receiving, from the UE, a measurement report associated with the data logging session, wherein the measurement report comprises at least one of: a log entry produced by the UE according to the logging entry structure, or data sampled by the UE according to the logging sampling interval.
